(19) United States
(12) Patent Application Publication
(10) Pub. No.: US 2026/0292443 A1
(43) Pub. Date: Sep. 24, 2026

(54) LOCATION DETERMINATION FOR HAZARD DETECTOR TESTING

(71) Applicant: NO CLIMB PRODUCTS LIMITED, Hertfordshire (GB)

(72) Inventors: Allen STUART, Hertfordshire (GB); Stewart PEPPER, Hertfordshire (GB); John BERTHELS, Hertfordshire (GB)

(21) Appl. No.: 19/472,594

(22) PCT Filed: Mar. 27, 2024
(86) PCT No.: PCT/GB2024/050831

§ 371 Date: Oct. 3, 2025

(30) Foreign Application Priority Data
Apr. 3, 2023 (GB) 2304950.5

(51) Int. Cl. H04W 4/02; G01S 1/04; G08B 25/10; G08B 29/14; H04W 4/80

(52) U.S. Cl. CPC H04W 4/025; G01S 1/042; G08B 25/10; G08B 29/145; H04W 4/80

(57) ABSTRACT

A system and corresponding method is provided for determining the location of a hazard detector testing apparatus that is to be used to test a hazard detector. The system may comprise: a sensing arrangement configured to detect a wireless signal from one or more wireless signal sources, the signal to be used to determine the location of the testing apparatus; a controller configured to determine the location of the testing apparatus based on the signal from the one or more wireless signal sources; and a storage unit configured to store data representative of the location of the testing apparatus. A hazard detector testing apparatus including a test tool that comprises the location determination system may also be provided.

### TECHNICAL FIELD

The present invention relates to testing the operation of hazard detectors and particularly determining the location of a hazard detector testing apparatus that is to carry out a test of the operation of hazard detectors.

### BACKGROUND

Hazard detection systems can utilise a variety of sensors to detect hazards, including smoke sensors, heat sensors, gas sensors, etc. Equipment to carry out functional testing of different types of hazard detector is already known. In such equipment, test stimulus can be designed to replicate the hazard in a non-hazardous fashion (e.g. heat, simulated smoke), so that the correct operation of the detector and/or the system can be verified without the risk of duplicating the real hazard (e.g. a real fire). Carrying out a functional test would normally require an operator to manually initiate a test on a hazard detector, determine whether a test was a success by manually checking for an output from the hazard detector under test, and then manually logging the result of the test before moving on to the next detector to be tested. This relies on an operator correctly carrying out an assessment and can be prone to errors. There is also the risk that the hazard detector under test has been tested already and/or is no longer in the same location as previously.

### SUMMARY OF THE INVENTION

From a first aspect, the present invention provides a system for determining the location of a hazard detector testing apparatus that is to be used to test a hazard detector, the system comprising: a sensing arrangement configured to detect a wireless signal from one or more wireless signal sources, the signal to be used to determine the location of the testing apparatus;
a controller configured to determine the location of the testing apparatus based on the signal from the one or more wireless signal sources; and a storage unit configured to store data representative of the location of the testing apparatus.

From a second aspect, the present invention provides method for determining the location of a hazard detector testing apparatus that is to be used to test a hazard detector, the method comprising: detecting a wireless signal from one or more wireless signal sources, the signal to be used to determine the location of the testing apparatus; determining the location of the testing apparatus based on the signal from the one or more wireless signal sources; and storing data representative of the location of the testing apparatus.

Further optional features relating to these aspects are provided in the appended dependent claims.

From a third aspect, the present invention provides a system for testing a hazard detector comprising a test tool that may include a dispenser for attachment to an elongate pole, the test tool further comprising the aforementioned location determining system of the first aspect.

### BRIEF DESCRIPTION OF THE DRAWINGS

Examples of the invention will now be described with reference to the accompanying drawings in which:

FIG. 1 shows a schematic diagram of the hazard detector testing system according to an example of the invention;

FIG. 2 shows a schematic disagree showing the hazard detector testing system of FIG. 1 and a plurality of wireless signal sources that may cause wireless radiation signals to be present in a building;

FIG. 3 shows a flow diagram of an example method for determining the location of a hazard detector testing system of FIG. 1;

FIG. 4 shows a schematic diagram of a test tool that includes some or all of the elements of the hazard detector testing system of FIG. 1.

### DETAILED DESCRIPTION

Examples described herein relate to automated location determination particularly by a hazard detector testing system of a hazard detector testing apparatus or device which is used to test hazard detectors, the hazard detectors being located in an indoor environment, for example, a building. The detectors may be located on a ceiling and/or wall of the building. The identity of the hazard detector testing apparatus' physical and geographical whereabouts and location of the position within a building, can be used to carry out one or more other actions such as to determine whether to carry out a test and/or other actions on the detector at or near that position. The result of the location determination within the building can be automatically recorded and correlated to a mapping of prestored detector locations including those stored within the hazard detector system. For example, where the detectors are smoke detectors to test for the presence of smoke indicative of a fire, prestored information relating to detector location may already be stored in a database. The determined location of the hazard detector testing apparatus as determined according to examples disclosed herein can then be correlated to a mapping of the prestored information relating to detector location that is stored in the database. The nearest detector location may be inferred or approximated from the determined location of the hazard detector testing apparatus when it is in proximity to the hazard detector.

In an example, the other action includes determining whether to carry out a test on the hazard detector within close proximity of the hazard detector testing apparatus. In an additional or alternative example, the hazard detector testing system can provide information relating to the determined location on a display. The displayed information can relate to historical information of the hazard detector testing environment, for example, the last maintenance of one or more detectors within close proximity of the hazard detector testing apparatus. The recording of location information within a building during maintenance activities such as hazard detector testing of hazard detection systems that may comprise a plurality of hazard detectors can enable an accurate and verifiable log to be determined and captured. It may also enable future repeat maintenance to be conducted in precisely the same locations as previous hazard detector maintenance activities.

The automated location determination that determines the position of a test to be carried out by a testing apparatus may be achieved through a number of different techniques. In an example, the location determination is achievable by using a wireless communication location determination system that is capable of detecting the transmissions of a plurality of wireless sources that may arranged to emit one or more wireless electromagnetic signals. The location determination system may include one or more transmitters of certain wavelengths of wireless radiation that could also be measured by a wireless signal sensing arrangement such as a wireless receiver to then determine a relative shift in received signal strength and the position of the wireless signal sensing arrangement. The one or more transmitters may be beacons that can be temporarily placed within an environment at the time that position determination is needed, for example, in a building where testing of a plurality of hazard detectors in the building may need to be selectively carried out.

The wireless signals to be received by the location determination system may relate to one or more wireless technologies including but not limited to: satellite-based positional signal (e.g. GPS), Wi-Fi, Bluetooth, GSM/GPRS/3G/4G/5G or others, to make that assessment. A combination of techniques including triangulation and trilateration/multilateration from Wi-Fi and/or Bluetooth sources, plus location data collected from mobile communication network such as GSM/GPRS/3G/4G/5G networks and a satellite-based GPS positional signal (if available), would permit a good level of accuracy for positioning. However, an adequate level of accuracy may be provided by one or more of these techniques or from reception or detection of only one wireless signal. Further, certainty of knowledge of the position within a building may be enhanced by other methods including movement and/or positional changes such as ‘dead reckoning’ using the aforementioned wireless systems in conjunction with compass/altimeter/accelerometer and other sensors as necessary that may be provided in the location determination system. These sensors may be processed with information relating to location from the received wireless signals from wireless sources to assist in location determination and may be housed within a common housing to means that determine location of the hazard detector testing system from the received wireless signals.

The location determining system may be in the form of a device or module that can be attached to a hazard detector testing apparatus to extend its functionality. In this case, the device is adapted to communicate with other functions of the hazard detector testing apparatus. The location determining system preferably forms part of the hazard detector testing system that comprises hazard detector testing apparatus that includes a stimulus generating arrangement configured to produce a test stimulus to test the hazard detector. The test stimulus is to cause a required response from the hazard detector, and the required response may be an appropriate alert or alarm signal emitted by the hazard detector.

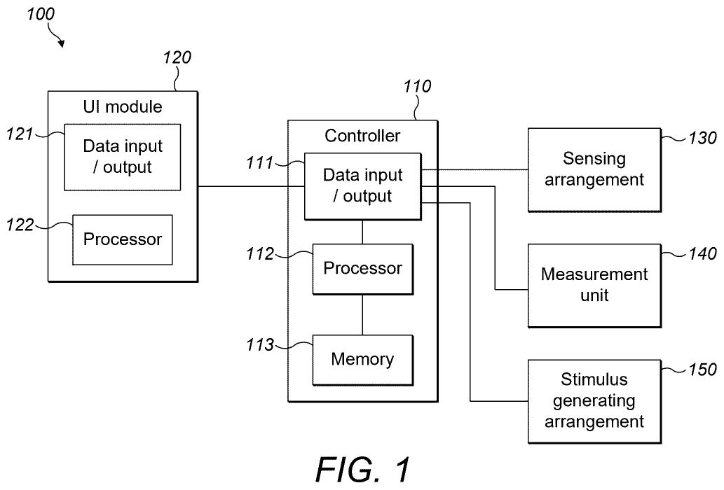

Referring to FIG. 1, there is shown an example of a hazard detector testing system 100 that is capable of determining location information.

In this example, the hazard detector testing system 100 comprises a controller 110. The controller may be configured to determine the location of the hazard detector testing system based on the signal from one or more wireless signal sources. The controller 110 may comprise a plurality of components, some of which are described below according to examples. The controller 110 may be a programmable logic device (PLD) or other computing device that can carry out instructions. The controller 110 may include multiple processing elements that are integrated in a single device as described in the example below or distributed across devices forming part of the hazard detector system 100.

The controller 110 of the hazard detector testing system 100 may comprise a controller data input/output unit 111 to receive input data from external components including, but not limited to, a user interface module 120 and a sensing arrangement 130. The controller data input/output unit 111 may also output data from the controller to other external components including, but not limited to, a stimulus generating arrangement 150. In an example, the controller data input/output unit 111 may comprise a transmitter arrangement to wirelessly send data from the controller 110 to a corresponding receiving device. In an example, the data sent wirelessly from the controller 110 via the controller data input/output unit 111 may be sent to a mobile communication device. In a further example, the data sent wirelessly from the controller 110 via the controller data input/output unit 111 may be sent to a Fire Control Panel (FCP). Hazard detection devices on which testing may be carried out by the hazard detector testing system 100 may be connected to the FCP, which is the central control point for the fire system in a building.

The controller 110 of the hazard detector testing system 100 may further comprise a processor 112 to manage all the components within the controller 110, and process all data flow between the components within the controller 110.

The controller 110 of the hazard detector testing system 100 may further comprise a memory unit 113 to store any data or instructions, which may need to be accessed at a later stage. The time extent to which the data is stored in the memory unit 113 may vary depending on the various data requirements of the controller 110. The hazard detector testing system 100 may comprise a further memory unit (not shown) to store data relating to information from the controller. The further memory unit may be removable from the hazard detector testing system 100.

The hazard detector testing system 100 as shown in FIG. 1 further comprises a user interface module 120 to allow a user to interact with the hazard detector testing system 100. The user interface module 120 may comprise a UI data input/output unit 121 to facilitate entry of the input data into the hazard detector testing system 100. The UI data input/output unit 121 may include a display screen and/or input devices (not shown) in the form of text buttons to allow user interaction and/or data input into the hazard detector testing system 100. In an example, the display screen may be a touch sensitive screen. The input data may be, but is not limited to, model and/or make information relating to any specific hazard detector. The user interface module 120 may process and send data input data to the controller 110 and may further comprise a processor 122 to receive and process the data input by the user which may then be sent to the controller 110 from the user interface module 120, via the UI data input/output module 121. In an example, the UI data input/output unit 121 may comprise a transmitter to wirelessly send data from the user interface module 120 to a corresponding receiving device. In an example, the corresponding receiving device may be the controller 110. In an example, the data sent wirelessly from the user interface module 120 via the UI data input/output unit 121 may be sent to a mobile communication device. In a further example, the data sent wirelessly from the user interface module 120 via the UI data input/output unit 121 may be sent to the Fire Control Panel (FCP).

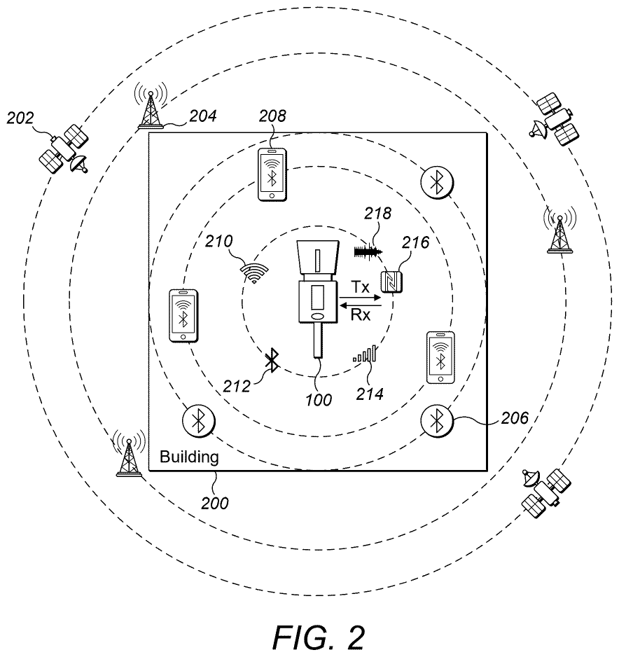

Referring to FIG. 1 and FIG. 2, the hazard detector testing system 100 further comprises the sensing arrangement 130 for detecting a wireless signal from one or more wireless signal sources (shown in FIG. 2), the signal to be used to determine the location of the testing apparatus which contains the sensing arrangement 130. The sensing arrangement 130 may generate data representative of the received wireless signal. The wireless signal may be one of a GPS, Bluetooth, GPRS, mobile or cellular wireless, LPWAN, or Wi-Fi communication signal. In the environment where a hazard detector test is to be carried out, such as in a building 200, there may be a plurality of wireless signals from different wireless signal sources. As shown in FIG. 2, the wireless signal sources may include sources of different types and one or more of: satellite source(s) 202 such as GPS/GLONASS/Beidou/Galileo 202; mobile communication network source(s) 204 such as GSM/GPRS/3G/4G/5G; Bluetooth source(s) 206 which may include one or more Bluetooth beacons located in the building 200; mobile phone source(s) 208 which may emit Bluetooth and/or Wi-Fi signals; and other wireless signals that may include ambient Wi-Fi electromagnetic radiation signal(s) 210, ambient Bluetooth electromagnetic radiation signal(s) 212, ambient cellular or mobile electromagnetic radiation signal(s) 214, near-field communication (NFC) signal(s) 216, and other ambient electromagnetic radiation source(s) 218. As shown by these different types of wireless signal sources as well as in FIG. 2, the wireless signal sources may be remote from or outside of an area surrounding a hazard detector to be tested. This provides the advantage of enabling the wireless signal sources not having to be installed in the area surrounding the hazard detector, where installing the wireless signal sources may be difficult to access in some indoor environments. The various wireless signals may be received by the sensing arrangement 130 that can generate data representative of the wireless signals and the data representative of the wireless signals may be used by the controller 110 to determine the location of the testing system 100 within the building. The source(s) of a wireless signal(s) which may be a radio frequency (RF) signal(s) may be uniquely identified and then an estimate of the location of the sensing arrangement 130 of the hazard detector testing system 100 may be determined on the basis of the identity of the source(s).

In an example, a triangulation technique is used by the controller 110 to determine the location of the testing apparatus. In another example, where three or more signal sources are present, a trilateration or multilateration technique is used to determine the location of the testing apparatus. It will be appreciated that not all signal sources need to be of the same type. A combination of triangulation or trilateration/multilateration techniques from the Wi-Fi and/or Bluetooth sources may be used, which may be augmented by location data collected from mobile communication network signal sources and/or GPS signal sources to determine the location of the testing apparatus. Therefore, in addition to data collected from wireless sources within the building 200, data from the mobile communication network signal sources and/or GPS signal sources can be used to enhance the accuracy of positional information. Known triangulation, trilateration and multilateration techniques may be used and will be appreciated by those skilled in the art.

Where the signal source is a Bluetooth source, this may in the form of one or a plurality of Bluetooth beacons that may already exist in a building and/or can be located at strategic/convenient positions manually prior to commencement of testing procedures of hazard detectors in the building 200. In the example of the Bluetooth beacon source, the beacon has a unique identification that can be provided to the hazard detector testing system 100 and an estimate of the approximate distance from the signal source can be determined, for example, by comparing the signal strength and received signal strength indication (RSSI). Similarly, for a Wi-Fi source, a media access control (MAC) address and/or a service set identified (SSID) can uniquely identify a signal source and an estimate of the approximate distance from the signal source can be determined based on RSSI information. In the case where an estimation of the approximate distance from the signal source does not provide a distance scale, relative positions can be inferred using trilateration or multilateration thereby allowing motion around the building 200 to be detected.

In an example, the controller 110 is located in a housing of the hazard detector testing apparatus that is used to test a hazard detector. In another example, the controller 110 may be located remote from the hazard detector testing apparatus and sensing arrangement 130 such that the determination of the location can be carried out remotely from the hazard detector testing apparatus and sensing arrangement 130.

The hazard detector testing system 100 may further include a measurement unit 140 to measure movement and position changes of the testing apparatus and generate measurement data. The controller 110 is configured to determine the location of the testing apparatus based on the signal from the one or more wireless signal sources 202-218 and measurement data from the measurement unit 140. Therefore, the certainty of knowledge of the position within a building may be enhanced by taking into account movement and/or positional changes such as ‘dead reckoning’ using the aforementioned one or more wireless signal sources 202-218 in conjunction with appropriate sensors (not shown) that may include a compass, altimeter, gyroscope, accelerometer and/or other sensors as necessary. The sensors may form part of an inertial measurement unit. The location information may be in the form of positional coordinates such as degree-minutes-seconds and the sensors may indicate an inertial force with respect to the x/y/z axes. These sensors are in communication with the controller 110 and may be housed within a housing of the testing apparatus along with the other components of the hazard detector testing system 100.

The hazard detector testing system 100 as shown in FIG. 1 further comprises the stimulus generating arrangement 150. The stimulus generating arrangement 150 is configured to release a stimulus to activate an alarm state of a hazard detector and may be conventional. The stimulus is to replicate a hazard in a non-hazardous fashion (e.g. heat, simulated smoke). The stimulus may vary depending on the type of hazard detector that is being tested. In an example, the stimulus generator 150 may generate a smoke, heat or carbon monoxide (CO) stimulus if the hazard detector being tested is a smoke, heat and/or CO detector respectively. The stimulus generator 150 may be capable of generating one or more of the test stimuli to test a multi-hazard detector that detects for different types of hazard such as smoke, heat and CO.

The hazard detector testing system 100 may further comprise a reading device (not shown) configured to read a hazard detector in close proximity to the hazard detector testing system 100 that is to carry out a test. The reading device may receive data from the hazard detector that is in close proximity to the hazard detector testing system 100. In an example, the alert or alarm signal from the hazard detector may be an electromagnetic visible light signal and may be automatically sensed by the reading device of the hazard detector testing system in a number of ways, examples of which are already disclosed in the Applicant's earlier patent application published as GB2592660 A which is incorporated herein by reference. The reading device may also receive data unique to the hazard detector.

The hazard detector testing system 100 may further comprise a transmitter arrangement (not shown) to wirelessly send location data of the testing apparatus as determined by the controller 110 to a receiving device. The transmitter arrangement may form an integral part of the sensing arrangement 130 which may be implemented by a transceiver. The receiving device may be a mobile communication device. The mobile communication device may be configured to receive the location information along with other information relating to the hazard detector system that is to be or is under test. The other information may include identification information of a hazard detector as received from the reading device such that relevant information can be analysed prior to a hazard detector test to determine whether to test a hazard detector that is in close proximity to the hazard detector testing system 100. In a further example, the data sent wirelessly may be sent to a Fire Control Panel (FCP).

The location of hazard detectors within the vicinity of the hazard detector testing system 100 can be determined without reference to the data from a hazard detector system that comprises the hazard detectors. When a detector is undergoing a test, and the location of the hazard detector testing system 100 is determined and known using the examples disclosed herein, by inference the location of the detector under test can be determined as during the test, the stimulus generating unit 150 of the hazard detector testing system 100 needs to be in close proximity to the detector to be tested. In an example, the hazard detector testing system 100 will be able to determine it is initiating a test procedure and therefore needing to initiate location determination automatically, for example, through activation of the reading device that is to read the hazard detector in close proximity to hazard detector testing system 100. Therefore, the reading device may assist in the determination that the hazard detector testing system 100 is engaged with and in close proximity to the hazard detector.

On the basis that the identity of the hazard detector is being inferred from the location of the hazard detector testing system 100, information relating to the location of detectors can be included in a database (not shown) that may be stored remotely from the environment containing the detectors, for example, in a Cloud server. Alternatively or additionally, the database may be stored locally in the hazard detector testing system 100 and may have been downloaded to storage in the hazard detector testing system prior to testing being carried out in the environment. The database may also maintain historical records of data related to previous tests and data of the detector's geographic position based on prior visits to test the same detector in that location.

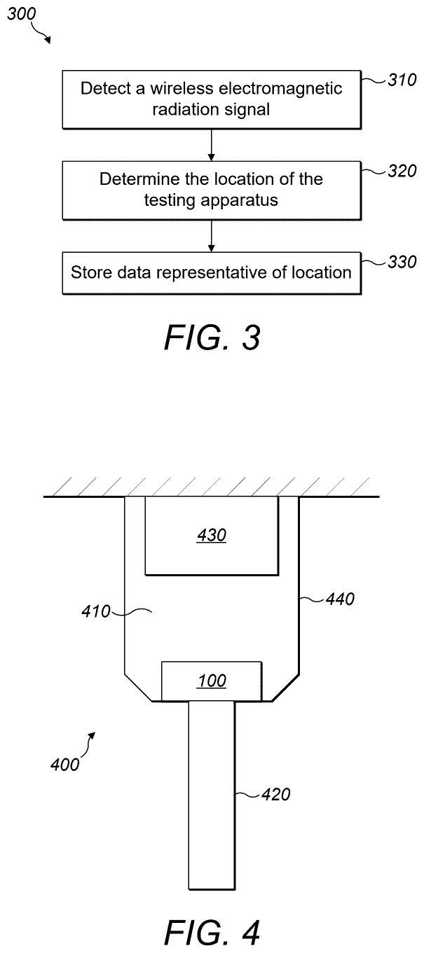

Referring to FIG. 3, there is shown a flow diagram of a method 300 of determining the location of a hazard detector testing apparatus using the hazard detector testing system 100. The method 300 includes detecting 310 a wireless signal from one or more wireless signal sources, the signal to be used to determine the location of the testing apparatus that is to test a hazard detector in an environment such as a building. The method further includes determining 320 the location of the testing apparatus based on the signal from the one or more wireless signal sources. The determination of the location may include (i) identifying a source(s) of wireless or RF emissions uniquely and (ii) performing an estimate of approximate distance. The specifics of (i) and (ii) are dependent on the nature of the specific wireless or RF source(s). The method also includes storing 330 data representative of the location of the testing apparatus.

The location of the testing apparatus can be used to infer the location of the hazard detector under test and information, such as historical information relating to testing of the hazard detector from a database, can be obtained by the controller 110 to assist in the determination of whether a test is to be performed on the hazard detector. The result of the determination may cause further action such as an alert on the UI module 120 or display of the hazard detector testing system 100 to indicate that user of the testing apparatus should initiate the test to be carried out by the testing apparatus on the proximal hazard detector. Alternatively, the test may be automatically carried out by the stimulus generating arrangement 130 of the system 100.

Referring to FIG. 4 (and FIG. 1 when referencing the example hazard detector testing system 100), there is shown a hazard detector testing apparatus 400. The hazard detector testing apparatus 400 comprises a test tool that is a dispenser 410 that includes an elongate pole 420 that may be attachable to the dispenser 410 to allow the test to be carried out on a hazard detector 430 that may be located on the ceiling of an environment such as a building. In an example, the dispenser 410 is formed an open topped housing 440 including a bottom and sidewall forming a cavity to receive a hazard detector 430. The open topped housing 440 may be transparent. In an example, components of the hazard detector testing system 100 (see FIG. 1) including the controller 110, sensing arrangement 130, measurement unit 140, and stimulus generating arrangement 150 are located within a module housing and located in the housing of the dispenser 410. In another example, the hazard detector testing system 100 may be removable and mechanically and electrically connected to another part of the hazard detector testing apparatus 400. In another example, it will be appreciated that the sensing arrangement 130 for detection of a wireless signal that assists in the determination of the location of the testing apparatus may be positioned in the testing apparatus that also contains the stimulus generating arrangement 150 that is to carry out a test on the nearest hazard detector. The controller 110 to determine the location of the testing apparatus based on the wireless signal may be located remotely from the testing apparatus such that the location determination according to examples disclosed herein can be carried out remotely. In this example, data representative of the wireless signal from the sensing arrangement 130 may be sent to the remote controller for processing and determination of the location of the testing apparatus. In other examples, the components for location determination (such as one or more of the controller 110, sensing arrangement 130, measurement unit 140) may be housed in their own module housing separate from the stimulus generating arrangement 150 of the hazard detector testing system 100 or other components of the system 100. The location determination module may include its own power source or may draw power from a power source of the hazard detector testing apparatus 400.

In addition to the examples described in detail above, the skilled person will recognize that various features described herein can be modified and/or combined with additional features, and the resulting additional examples can be implemented without departing from the scope of the system of the present disclosure, as this specification merely sets forth some of the many possible example configurations and implementations for the claimed solution.

1. System for determining the location of a hazard detector testing apparatus that is to be used to test a hazard detector, comprising:
a sensing arrangement configured to detect a wireless signal from one or more wireless signal sources, the signal to be used to determine the location of the testing apparatus;
a controller configured to determine the location of the testing apparatus based on the signal from the one or more wireless signal sources; and
a storage unit configured to store data representative of the location of the testing apparatus.

2-3. (canceled)

4. The system of claim 1, wherein a stimulus generating arrangement is configured to produce a test stimulus based, at least in part, on the location of the testing apparatus.

5-7. (canceled)

8. The system of claim 1, wherein the sensing arrangement is to detect a plurality of wireless signals from different wireless signal sources comprising Bluetooth beacons that are transportable and capable of being positioned manually in an environment comprising a plurality of hazard detectors prior to commencement of hazard detector testing procedures in the environment.

9-10. (canceled)

11. The system of claim 1, wherein the controller use a trilateration or multilateration technique to determine the location of the testing apparatus.

12. The system of claim 1, wherein the controller uses a combination of triangulation or trilateration techniques from Wi-Fi and/or Bluetooth sources, which are augmented by location data collected from a mobile communication network and/or GPS signal to determine the location of the testing apparatus.

13. The system of claim 1, further comprising a measurement unit to measure movement and position changes of the testing apparatus and generate measurement data, and the controller is configured to determine the location of the testing apparatus based on the signal from the one or more wireless signal sources and measurement data from the measurement unit.

14. The system of claim 13, wherein the measurement unit comprises one or more of: compass; altimeter; and accelerometer.

15. The system of claim 1, wherein the sensing arrangement, controller and storage unit are housed in a common housing.

16. The system of claim 1, further comprising a reading device configured to read a hazard detector in close proximity to the testing apparatus and to receive data unique to the hazard detector which includes data representing the identity of the hazard detector that is in close proximity to the testing apparatus.

17. (canceled)

18. The system of claim 1, wherein the controller is located in a housing of the hazard detector testing apparatus.

19. A method for determining the location of a hazard detector testing apparatus that is to be used to test a hazard detector, the method comprising:
detecting a wireless signal from one or more wireless signal sources, the signal to be used to determine the location of the testing apparatus;
determining the location of the testing apparatus based on the signal from the one or more wireless signal sources; and
storing data representative of the location of the testing apparatus.

20-21. (canceled)

22. The method of claim 19 wherein a stimulus generating arrangement is configured to generate a test stimulus based, at least in part, on the location of the testing apparatus.

23-27. (canceled)

28. The method of claim 19, wherein a trilateration or multilateration technique is used to determine the location of the testing apparatus.

29. The method of any one of claim 19, wherein a combination of triangulation or trilateration techniques are used from Wi-Fi and/or Bluetooth sources, which are augmented by location data collected from mobile communication networks and/or GPS signals to determine the location of the testing apparatus.

30. The method of claim 19, further comprising measuring movement and position changes of the testing apparatus and generating measurement data, and determination of the location of the testing apparatus is based on the signal from the one or more wireless signal sources and measurement data from the measurement unit.

31. The method of claim 30, wherein the measuring is carried out by a measurement unit comprising one or more of: compass; altimeter; and accelerometer.

32. The method of any one of claim 19, further comprising reading a hazard detector in close proximity to the testing apparatus and receiving data unique to the hazard detector which includes data representing the identity of the hazard detector that is in close proximity to the testing apparatus.

33. The method of claim 19, wirelessly sending data from the testing apparatus to a receiving device.

34. The method of claim 19, wherein the controller is located in a housing of the hazard detector testing apparatus.

35. A hazard detector testing system, comprising a hazard detector testing apparatus including a test tool further comprising the location determining system of claim 1.

36-41. (canceled)
